(19) United States
(12) Patent Application Publication
(10) Pub. No.: US 2024/0068189 A1
(43) Pub. Date: Feb. 29, 2024

(54) OVERRIDING CONTROL OF MOTORIZED TRANSPORT UNIT SYSTEMS, DEVICES AND METHODS

(71) Applicant: Walmart Apollo, LLC, Bentonville, AR (US)

(72) Inventors: Donald R. High, Noel, MO (US); Michael D. Atchley, Eureka Springs, AR (US); Karl Kay, Gentry, AR (US); David C. Winkle, Leesburg, FL (US)

(21) Appl. No.: 18/385,282

(22) Filed: Oct. 30, 2023

Related U.S. Application Data
(63) Continuation-in-part of application No. 17/081,657, filed on Oct. 27, 2020, now Pat. No. 11,840,814.
Application No. 17/081,657 is a continuation of application No. 16/001,774, filed on Jun. 6, 2018, now abandoned.
Application No. 16/001,774 is a continuation of application No. 15/061,350, filed on Mar. 4, 2016, now Pat. No. 9,994,434.
(60) Provisional application No. 62/303,021, filed on Mar. 3, 2016.
(60) Provisional application No. 62/302,547, filed on Mar. 2, 2016.
(60) Provisional application No. 62/302,567, filed on Mar. 2, 2016.
(60) Provisional application No. 62/302,713, filed on Mar. 2, 2016.
(60) Provisional application No. 62/292,084, filed on Feb. 5, 2016.
(60) Provisional application No. 62/214,826, filed on Sep. 4, 2015.
(60) Provisional application No. 62/214,824, filed on Sep. 4, 2015.
(60) Provisional application No. 62/207,858, filed on Aug. 20, 2015.
(60) Provisional application No. 62/205,539, filed on Aug. 14, 2015.
(60) Provisional application No. 62/205,548, filed on Aug. 14, 2015.
(60) Provisional application No. 62/205,569, filed on Aug. 14, 2015.
(60) Provisional application No. 62/205,555, filed on Aug. 14, 2015.
(60) Provisional application No. 62/202,744, filed on Aug. 7, 2015.
(60) Provisional application No. 62/202,747, filed on Aug. 7, 2015.
(60) Provisional application No. 62/194,131, filed on Jul. 17, 2015.
(60) Provisional application No. 62/194,127, filed on Jul. 17, 2015.
(60) Provisional application No. 62/194,121, filed on Jul. 17, 2015.
(60) Provisional application No. 62/194,119, filed on Jul. 17, 2015.
(60) Provisional application No. 62/185,478, filed on Jun. 26, 2015.
(60) Provisional application No. 62/182,339, filed on Jun. 19, 2015.
(60) Provisional application No. 62/175,182, filed on Jun. 12, 2015.
(60) Provisional application No. 62/171,822, filed on Jun. 5, 2015.
(60) Provisional application No. 62/165,416, filed on May 22, 2015.
(60) Provisional application No. 62/165,579, filed on May 22, 2015.
(60) Provisional application No. 62/165,586, filed on May 22, 2015.
(60) Provisional application No. 62/157,388, filed on May 5, 2015.
(60) Provisional application No. 62/152,421, filed on Apr. 24, 2015.
(60) Provisional application No. 62/152,440, filed on Apr. 24, 2015.
(60) Provisional application No. 62/152,465, filed on Apr. 24, 2015.
(60) Provisional application No. 62/152,610, filed on Apr. 24, 2015.
(60) Provisional application No. 62/152,667, filed on Apr. 24, 2015.
(60) Provisional application No. 62/152,711, filed on Apr. 24, 2015.
(60) Provisional application No. 62/152,630, filed on Apr. 24, 2015.
(60) Provisional application No. 62/138,877, filed on Mar. 26, 2015.
(60) Provisional application No. 62/138,885, filed on Mar. 26, 2015.
(60) Provisional application No. 62/129,727, filed on Mar. 6, 2015.
(60) Provisional application No. 62/129,726, filed on Mar. 6, 2015.

(51) Int. Cl. E01H 5/06; A47F 3/08; A47F 10/04; A47F 13/00; A47L 11/40; B07C 5/28; B07C 5/342; B60L 53/36; B60L 53/63; B60P 3/06; B62B 5/00; B65F 3/00; B66F 9/06; E01H 5/12; G01C 21/20; G01S 1/02; G01S 1/70; G01S 1/72; G05B 19/048; G05D 1/00; G05D 1/02; G05D 1/04; G06F 3/01; G06F 18/214; G06Q 10/02; G06Q 10/0631; G06Q 10/083; G06Q 10/087; G06Q 10/1093; G06Q 10/30; G06Q 30/016; G06Q 30/02; G06Q 30/0601; G06Q 50/28; G06Q 50/30; G06T 7/593; G06T 7/73; G06V 20/20; G06V 20/40; G06V 20/52; G06V 20/56; G06V 20/58; G06V 20/64; G06V 30/224; G08G 1/00; G10L 13/00; G10L 15/22; G10L 17/22; H02J 7/00; H04B 10/116; H04L 67/12; H04L 67/141; H04L 67/143; H04N 5/77; H04N 7/18; H04N 13/282; H04W 4/02; H04W 4/021; H04W 4/029; H04W 4/30; H04W 4/33; H04W 4/40; H04W 4/80

(52) U.S. Cl. CPC E01H 5/061; A47F 3/08; A47F 10/04; A47F 13/00; A47L 11/4011; B07C 5/28; B07C 5/3422; B60L 53/36; B60L 53/63; B60P 3/06; B62B 5/0026; B62B 5/0069; B62B 5/0076; B65F 3/00; B66F 9/063; E01H 5/12; G01C 21/206; G01S 1/02; G01S 1/70; G01S 1/7034; G01S 1/7038; G01S 1/72; G05B 19/048; G05D 1/0011; G05D 1/0016; G05D 1/0022; G05D 1/0027; G05D 1/0061; G05D 1/0088; G05D 1/021; G05D 1/0214; G05D 1/0219; G05D 1/0234; G05D 1/0246; G05D 1/0255; G05D 1/0276; G05D 1/028; G05D 1/0289; G05D 1/0291; G05D 1/0293; G05D 1/0297; G05D 1/04; G06F 3/017; G06F 18/214; G06Q 10/02; G06Q 10/0631; G06Q 10/06311; G06Q 10/083; G06Q 10/087; G06Q 10/1095; G06Q 10/30; G06Q 30/016; G06Q 30/0281; G06Q 30/0601; G06Q 30/0605; G06Q 30/0613; G06Q 30/0617; G06Q 30/0619; G06Q 30/0631; G06Q 30/0633; G06Q 30/0635; G06Q 30/0639; G06Q 30/0641; G06Q 50/28; G06Q 50/30; G06T 7/593; G06T 7/74; G06V 20/20; G06V 20/40; G06V 20/52; G06V 20/56; G06V 20/58; G06V 20/647; G06V 30/224; G08G 1/20; G10L 13/00; G10L 15/22; G10L 17/22; H02J 7/0013; H02J 7/0071; H04B 10/116; H04L 67/12; H04L 67/141; H04L 67/143; H04N 5/77; H04N 7/18; H04N 7/183; H04N 7/185; H04N 13/282; H04W 4/02; H04W 4/021; H04W 4/029; H04W 4/30; H04W 4/33; H04W 4/40; H04W 4/80; G06F 16/90335; Y02W 30/82

(57) ABSTRACT

Some embodiments include apparatuses providing control over movement of motorized transport units at a retail facility, comprising: multiple self-propelled motorized transport units; a wireless communication network; and a central computer system, wherein the central computer system comprises: a transceiver; a control circuit; and a memory storing computer instructions that when executed cause the control circuit to: receive an override command, from a worker associated with the retail facility, to cause a first motorized transport unit of the multiple motorized transport units to implement one or more actions; confirm a valid authorization of the worker to override one or more operating limits of the first motorized transport unit; and override the one or more operating limits and communicate one or more instructions to the first motorized transport unit configured to cause the first motorized transport unit to implement the one or more actions in accordance with the override command.

### RELATED APPLICATIONS

This application is a continuation of U.S. application Ser. No. 17/081,657, filed Oct. 27, 2020, which is incorporated herein by reference in its entirety and which is a continuation of U.S. application Ser. No. 16/001,774, filed Jun. 6, 2018, which is incorporated herein by reference in its entirety and which is a continuation of U.S. application Ser. No. 15/061,350, filed Mar. 4, 2016, Docket 8842-134589-US_624U502, which is incorporated herein by reference in its entirety and which claims the benefit of each of the following U.S. Provisional applications, each of which is incorporated herein by reference in its entirety: U.S. Provisional Application No. 62/129,726, filed Mar. 6, 2015, Docket 8842-134158-US (587US01); U.S. Provisional Application No. 62/129,727, filed Mar. 6, 2015, Docket 8842-134268-US (615US01); U.S. Provisional Application No. 62/138,877, filed Mar. 26, 2015, Docket 8842-134162-US (610US01); U.S. Provisional Application No. 62/138,885, filed Mar. 26, 2015, Docket 8842-134209-US (635US01); U.S. Provisional Application No. 62/152,421, filed Apr. 24, 2015, Docket 8842-134155-US (608US01); U.S. Provisional Application No. 62/152,465, filed Apr. 24, 2015, Docket 8842-134161-US (603US01); U.S. Provisional Application No. 62/152,440, filed Apr. 24, 2015, Docket 8842-134208-US (611US01); U.S. Provisional Application No. 62/152,630, filed Apr. 24, 2015, Docket 8842-134249-US (612US01); U.S. Provisional Application No. 62/152,711, filed Apr. 24, 2015, Docket 8842-134269-US (626US01); U.S. Provisional Application No. 62/152,610, filed Apr. 24, 2015, Docket 8842-134574-US (623US01); U.S. Provisional Application No. 62/152,667, filed Apr. 24, 2015, Docket 8842-134575-US (663US01); U.S. Provisional Application No. 62/157,388, filed May 5, 2015, Docket 8842-134573-US (606US01); U.S. Provisional Application No. 62/165,579, filed May 22, 2015, Docket 8842-134576-US (677US01); U.S. Provisional Application No. 62/165,416, filed May 22, 2015, Docket 8842-134589-US (624US01); U.S. Provisional Application No. 62/165,586, filed May 22, 2015, Docket 8842-134945-US (732US01); U.S. Provisional Application No. 62/171,822, filed Jun. 5, 2015, Docket 8842-134250-US (621US01); U.S. Provisional Application No. 62/175,182, filed Jun. 12, 2015, Docket 8842-135963-US (726US01); U.S. Provisional Application No. 62/182,339, filed Jun. 19, 2015, Docket 8842-135961-US (749US01); U.S. Provisional Application No. 62/185,478, filed Jun. 26, 2015, Docket 8842-136023-US (742US01); U.S. Provisional Application No. 62/194,131, filed Jul. 17, 2015, Docket 8842-135962-US (739US01); U.S. Provisional Application No. 62/194,119, filed Jul. 17, 2015, Docket 8842-136020-US (728US01); U.S. Provisional Application No. 62/194,121, filed Jul. 17, 2015, Docket 8842-136022-US (740US01); U.S. Provisional Application No. 62/194,127, filed Jul. 17, 2015, Docket 8842-136024-US (743US01); U.S. Provisional Application No. 62/202,744, filed Aug. 7, 2015, Docket 8842-135956-US (764US01); U.S. Provisional Application No. 62/202,747, filed Aug. 7, 2015, Docket 8842-136021-US (734US01); U.S. Provisional Application No. 62/205,548, filed Aug. 14, 2015, Docket 8842-135959-US (751US01); U.S. Provisional Application No. 62/205,569, filed Aug. 14, 2015, Docket 8842-136123-US (680US01); U.S. Provisional Application No. 62/205,555, filed Aug. 14, 2015, Docket 8842-136124-US (741US01); U.S. Provisional Application No. 62/205,539, filed Aug. 14, 2015, Docket 8842-136651-US (919US01); U.S. Provisional Application No. 62/207,858, filed Aug. 20, 2015, Docket 8842-136508-US (854US01); U.S. Provisional Application No. 62/214,826, filed Sep. 4, 2015, Docket 8842-136026-US (746US01); U.S. Provisional Application No. 62/214,824, filed Sep. 4, 2015, Docket 8842-136025-US (744US01); U.S. Provisional Application No. 62/292,084, filed Feb. 5, 2016, Docket 8842-137833-US (925US01); U.S. Provisional Application No. 62/302,547, filed Mar. 2, 2016, Docket 8842-136125-US (748US01); U.S. Provisional Application No. 62/302,567, filed Mar. 2, 2016, Docket 8842-138040-US (731US01); U.S. Provisional Application No. 62/302,713, filed Mar. 2, 2016, Docket 8842-137834-US (932US01); and U.S. Provisional Application No. 62/303,021, filed Mar. 3, 2016, Docket 8842-137831-US (636US01).

### TECHNICAL FIELD

These teachings relate generally to shopping environments and more particularly to devices, systems and methods for assisting customers and/or workers in those shopping environments.

### BACKGROUND

In a modern retail store environment, there is a need to improve the customer experience and/or convenience for the customer. Whether shopping in a large format (big box) store or smaller format (neighborhood) store, customers often require assistance that employees of the store are not always able to provide. For example, particularly during peak hours, there may not be enough employees available to assist customers such that customer questions go unanswered. Additionally, due to high employee turnover rates, available employees may not be fully trained or have access to information to adequately support customers. Other routine tasks also are difficult to keep up with, particularly during peak hours. For example, shopping carts are left abandoned, aisles become messy, inventory is not displayed in the proper locations or is not even placed on the sales floor, shelf prices may not be properly set, and theft is hard to discourage. All of these issues can result in low customer satisfaction or reduced convenience to the customer. With increasing competition from non-traditional shopping mechanisms, such as online shopping provided by e-commerce merchants and alternative store formats, it can be important for “brick and mortar” retailers to focus on improving the overall customer experience and/or convenience.

### BRIEF DESCRIPTION OF THE DRAWINGS

The above needs are at least partially met through provision of embodiments of systems, devices, and methods designed to provide assistance to customers and/or workers in a shopping facility, such as described in the following detailed description, particularly when studied in conjunction with the drawings, wherein:

FIG. 1 comprises a block diagram of a shopping assistance system as configured in accordance with various embodiments of these teachings;

FIGS. 2A and 2B are illustrations of a motorized transport unit of the system of FIG. 1 in a retracted orientation and an extended orientation in accordance with some embodiments;

FIGS. 3A and 3B are illustrations of the motorized transport unit of FIGS. 2A and 2B detachably coupling to a movable item container, such as a shopping cart, in accordance with some embodiments;

FIG. 4 comprises a block diagram of a motorized transport unit as configured in accordance with various embodiments of these teachings;

FIG. 5 comprises a block diagram of a computer device as configured in accordance with various embodiments of these teachings;

FIG. 6 shows a simplified flow diagram of an exemplary process of implementing an override of a motorized transport unit, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally speaking, pursuant to various embodiments, systems, devices and methods are provided for assistance of persons at a shopping facility. Generally, assistance may be provided to customers or shoppers at the facility and/or to workers at the facility. The facility may be any type of shopping facility at a location in which products for display and/or for sale are variously distributed throughout the shopping facility space. The shopping facility may be a retail sales facility, or any other type of facility in which products are displayed and/or sold. The shopping facility may include one or more of sales floor areas, checkout locations, parking locations, entrance and exit areas, stock room areas, stock receiving areas, hallway areas, common areas shared by merchants, and so on. Generally, a shopping facility includes areas that may be dynamic in terms of the physical structures occupying the space or area and objects, items, machinery and/or persons moving in the area. For example, the shopping area may include product storage units, shelves, racks, modules, bins, etc., and other walls, dividers, partitions, etc. that may be configured in different layouts or physical arrangements. In other examples, persons or other movable objects may be freely and independently traveling through the shopping facility space. And in other examples, the persons or movable objects move according to known travel patterns and timing. The facility may be any size of format facility, and may include products from one or more merchants. For example, a facility may be a single store operated by one merchant or may be a collection of stores covering multiple merchants such as a mall. Generally, the system makes use of automated, robotic mobile devices, e.g., motorized transport units, that are capable of self-powered movement through a space of the shopping facility and providing any number of functions. Movement and operation of such devices may be controlled by a central computer system or may be autonomously controlled by the motorized transport units themselves. Various embodiments provide one or more user interfaces to allow various users to interact with the system including the automated mobile devices and/or to directly interact with the automated mobile devices. In some embodiments, the automated mobile devices and the corresponding system serve to enhance a customer shopping experience in the shopping facility, e.g., by assisting shoppers and/or workers at the facility.

In some embodiments, a shopping facility personal assistance system comprises: a plurality of motorized transport units located in and configured to move through a shopping facility space; a plurality of user interface units, each corresponding to a respective motorized transport unit during use of the respective motorized transport unit; and a central computer system having a network interface such that the central computer system wirelessly communicates with one or both of the plurality of motorized transport units and the plurality of user interface units, wherein the central computer system is configured to control movement of the plurality of motorized transport units through the shopping facility space based at least on inputs from the plurality of user interface units.

System Overview

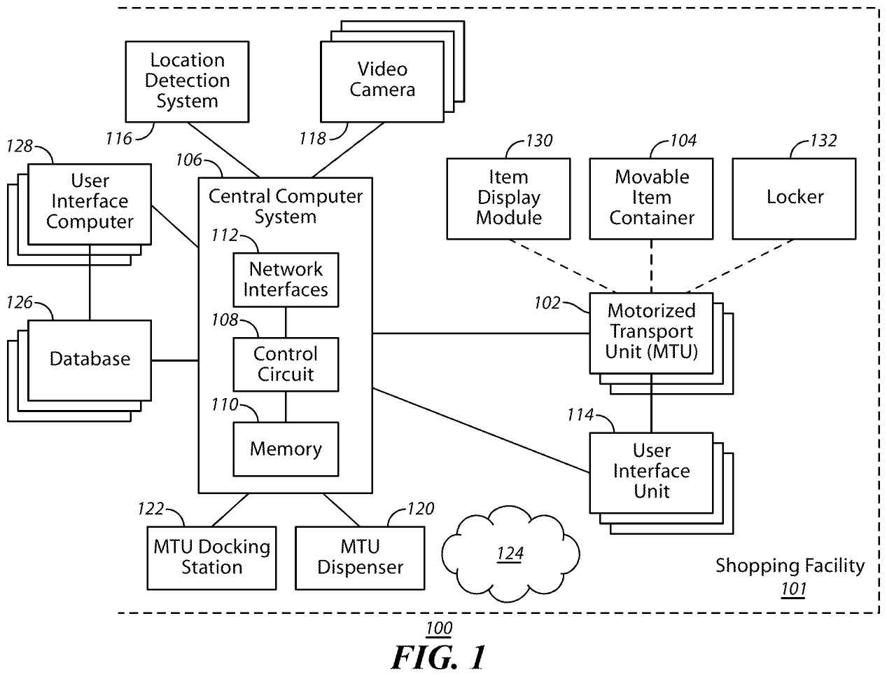

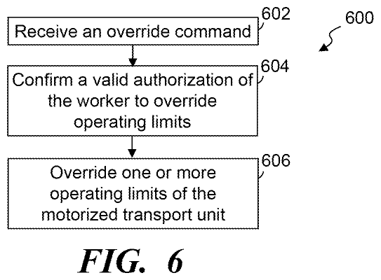

Referring now to the drawings, FIG. 1 illustrates embodiments of a shopping facility assistance system 100 that can serve to carry out at least some of the teachings set forth herein. It will be understood that the details of this example are intended to serve in an illustrative capacity and are not necessarily intended to suggest any limitations as regards the present teachings. It is noted that generally, FIGS. 1-5 describe the general functionality of several embodiments of a system, and FIG. 6 expands on some functionalities of some embodiments of the system and/or embodiments independent of such systems.

In the example of FIG. 1, a shopping assistance system 100 is implemented in whole or in part at a shopping facility 101. Generally, the system 100 includes one or more motorized transport units (MTUs) 102; one or more item containers 104; a central computer system 106 having at least one control circuit 108, at least one memory 110 and at least one network interface 112; at least one user interface unit 114; a location determination system 116; at least one video camera 118; at least one motorized transport unit (MTU) dispenser 120; at least one motorized transport unit (MTU) docking station 122; at least one wireless network 124; at least one database 126; at least one user interface computer device 128; an item display module 130; and a locker or an item storage unit 132. It is understood that more or fewer of such components may be included in different embodiments of the system 100.

These motorized transport units 102 are located in the shopping facility 101 and are configured to move throughout the shopping facility space. Further details regarding such motorized transport units 102 appear further below. Generally speaking, these motorized transport units 102 are configured to either comprise, or to selectively couple to, a corresponding movable item container 104. A simple example of an item container 104 would be a shopping cart as one typically finds at many retail facilities, or a rocket cart, a flatbed cart or any other mobile basket or platform that may be used to gather items for potential purchase.

In some embodiments, these motorized transport units 102 wirelessly communicate with, and are wholly or largely controlled by, the central computer system 106. In particular, in some embodiments, the central computer system 106 is configured to control movement of the motorized transport units 102 through the shopping facility space based on a variety of inputs. For example, the central computer system 106 communicates with each motorized transport unit 102 via the wireless network 124 which may be one or more wireless networks of one or more wireless network types (such as, a wireless local area network, a wireless personal area network, a wireless mesh network, a wireless star network, a wireless wide area network, a cellular network, and so on), capable of providing wireless coverage of the desired range of the motorized transport units 102 according to any known wireless protocols, including but not limited to a cellular, Wi-Fi, Zigbee or Bluetooth network.

By one approach the central computer system 106 is a computer based device and includes at least one control circuit 108, at least one memory 110 and at least one wired and/or wireless network interface 112. Such a control circuit 108 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description here. This control circuit 108 is configured (for example, by using corresponding programming stored in the memory 110 as will be well understood by those skilled in the art) to carry out one or more of the steps, actions, and/or functions described herein.

In this illustrative example the control circuit 108 operably couples to one or more memories 110. The memory 110 may be integral to the control circuit 108 or can be physically discrete (in whole or in part) from the control circuit 108 as desired. This memory 110 can also be local with respect to the control circuit 108 (where, for example, both share a common circuit board, chassis, power supply, and/or housing) or can be partially or wholly remote with respect to the control circuit 108 (where, for example, the memory 110 is physically located in another facility, metropolitan area, or even country as compared to the control circuit 108).

This memory 110 can serve, for example, to non-transitorily store the computer instructions that, when executed by the control circuit 108, cause the control circuit 108 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

Additionally, at least one database 126 may be accessible by the central computer system 106. Such databases may be integrated into the central computer system 106 or separate from it. Such databases may be at the location of the shopping facility 101 or remote from the shopping facility 101. Regardless of location, the databases comprise memory to store and organize certain data for use by the central control system 106. In some embodiments, the at least one database 126 may store data pertaining to one or more of: shopping facility mapping data, customer data, customer shopping data and patterns, inventory data, product pricing data, and so on.

In this illustrative example, the central computer system 106 also wirelessly communicates with a plurality of user interface units 114. These teachings will accommodate a variety of user interface units including, but not limited to, mobile and/or handheld electronic devices such as so-called smart phones and portable computers such as tablet/pad-styled computers. Generally speaking, these user interface units 114 should be able to wirelessly communicate with the central computer system 106 via a wireless network, such as the wireless network 124 of the shopping facility 101 (such as a Wi-Fi wireless network). These user interface units 114 generally provide a user interface for interaction with the system. In some embodiments, a given motorized transport unit 102 is paired with, associated with, assigned to or otherwise made to correspond with a given user interface unit 114. In some embodiments, these user interface units 114 should also be able to receive verbally-expressed input from a user and forward that content to the central computer system 106 or a motorized transport unit 102 and/or convert that verbally-expressed input into a form useful to the central computer system 106 or a motorized transport unit 102.

By one approach at least some of the user interface units 114 belong to corresponding customers who have come to the shopping facility 101 to shop. By another approach, in lieu of the foregoing or in combination therewith, at least some of the user interface units 114 belong to the shopping facility 101 and are loaned to individual customers to employ as described herein. In some embodiments, one or more user interface units 114 are attachable to a given movable item container 104 or are integrated with the movable item container 104. Similarly, in some embodiments, one or more user interface units 114 may be those of shopping facility workers, belong to the shopping facility 101 and are loaned to the workers, or a combination thereof.

In some embodiments, the user interface units 114 may be general purpose computer devices that include computer programming code to allow it to interact with the system 106. For example, such programming may be in the form of an application installed on the user interface unit 114 or in the form of a browser that displays a user interface provided by the central computer system 106 or other remote computer or server (such as a web server). In some embodiments, one or more user interface units 114 may be special purpose devices that are programmed to primarily function as a user interface for the system 100. Depending on the functionality and use case, user interface units 114 may be operated by customers of the shopping facility or may be operated by workers at the shopping facility, such as facility employees (associates or colleagues), vendors, suppliers, contractors, etc.

By one approach, the system 100 optionally includes one or more video cameras 118. Captured video imagery from such a video camera 118 can be provided to the central computer system 106. That information can then serve, for example, to help the central computer system 106 determine a present location of one or more of the motorized transport units 102 and/or determine issues or concerns regarding automated movement of those motorized transport units 102 in the shopping facility space. As one simple example in these regards, such video information can permit the central computer system 106, at least in part, to detect an object in a path of movement of a particular one of the motorized transport units 102.

By one approach these video cameras 118 comprise existing surveillance equipment employed at the shopping facility 101 to serve, for example, various security purposes. By another approach these video cameras 118 are dedicated to providing video content to the central computer system 106 to facilitate the latter's control of the motorized transport units 102. If desired, the video cameras 118 can have a selectively movable field of view and/or zoom capability that the central computer system 106 controls as appropriate to help ensure receipt of useful information at any given moment.

In some embodiments, a location detection system 116 is provided at the shopping facility 101. The location detection system 116 provides input to the central computer system 106 useful to help determine the location of one or more of the motorized transport units 102. In some embodiments, the location detection system 116 includes a series of light sources (e.g., LEDs (light-emitting diodes)) that are mounted in the ceiling at known positions throughout the space and that each encode data in the emitted light that identifies the source of the light (and thus, the location of the light). As a given motorized transport unit 102 moves through the space, light sensors (or light receivers) at the motorized transport unit 102, on the movable item container 104 and/or at the user interface unit 114 receive the light and can decode the data. This data is sent back to the central computer system 106 which can determine the position of the motorized transport unit 102 by the data of the light it receives, since it can relate the light data to a mapping of the light sources to locations at the facility 101. Generally, such lighting systems are known and commercially available, e.g., the ByteLight system from ByteLight of Boston, Massachusetts. In embodiments using a ByteLight system, a typical display screen of the typical smart phone device can be used as a light sensor or light receiver to receive and process data encoded into the light from the ByteLight light sources.

In other embodiments, the location detection system 116 includes a series of low energy radio beacons (e.g., Bluetooth low energy beacons) at known positions throughout the space and that each encode data in the emitted radio signal that identifies the beacon (and thus, the location of the beacon). As a given motorized transport unit 102 moves through the space, low energy receivers at the motorized transport unit 102, on the movable item container 104 and/or at the user interface unit 114 receive the radio signal and can decode the data. This data is sent back to the central computer system 106 which can determine the position of the motorized transport unit 102 by the location encoded in the radio signal it receives, since it can relate the location data to a mapping of the low energy radio beacons to locations at the facility 101. Generally, such low energy radio systems are known and commercially available. In embodiments using a Bluetooth low energy radio system, a typical Bluetooth radio of a typical smart phone device can be used as a receiver to receive and process data encoded into the Bluetooth low energy radio signals from the Bluetooth low energy beacons.

In still other embodiments, the location detection system 116 includes a series of audio beacons at known positions throughout the space and that each encode data in the emitted audio signal that identifies the beacon (and thus, the location of the beacon). As a given motorized transport unit 102 moves through the space, microphones at the motorized transport unit 102, on the movable item container 104 and/or at the user interface unit 114 receive the audio signal and can decode the data. This data is sent back to the central computer system 106 which can determine the position of the motorized transport unit 102 by the location encoded in the audio signal it receives, since it can relate the location data to a mapping of the audio beacons to locations at the facility 101. Generally, such audio beacon systems are known and commercially available. In embodiments using an audio beacon system, a typical microphone of a typical smart phone device can be used as a receiver to receive and process data encoded into the audio signals from the audio beacon.

Also optionally, the central computer system 106 can operably couple to one or more user interface computers 128 (comprising, for example, a display and a user input interface such as a keyboard, touch screen, and/or cursor-movement device). Such a user interface computer 128 can permit, for example, a worker (e.g., an associate, analyst, etc.) at the retail or shopping facility 101 to monitor the operations of the central computer system 106 and/or to attend to any of a variety of administrative, configuration or evaluation tasks as may correspond to the programming and operation of the central computer system 106. Such user interface computers 128 may be at or remote from the location of the facility 101 and may access one or more the databases 126.

In some embodiments, the system 100 includes at least one motorized transport unit (MTU) storage unit or dispenser 120 at various locations in the shopping facility 101. The dispenser 120 provides for storage of motorized transport units 102 that are ready to be assigned to customers and/or workers. In some embodiments, the dispenser 120 takes the form of a cylinder within which motorized transports units 102 are stacked and released through the bottom of the dispenser 120. Further details of such embodiments are provided further below. In some embodiments, the dispenser 120 may be fixed in location or may be mobile and capable of transporting itself to a given location or utilizing a motorized transport unit 102 to transport the dispenser 120, then dispense one or more motorized transport units 102.

In some embodiments, the system 100 includes at least one motorized transport unit (MTU) docking station 122. These docking stations 122 provide locations where motorized transport units 102 can travel and connect to. For example, the motorized transport units 102 may be stored and charged at the docking station 122 for later use, and/or may be serviced at the docking station 122.

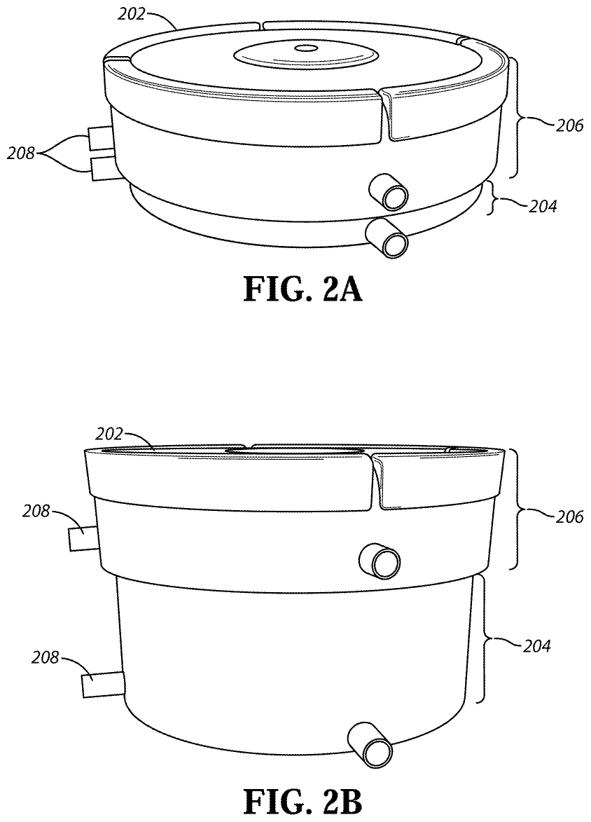

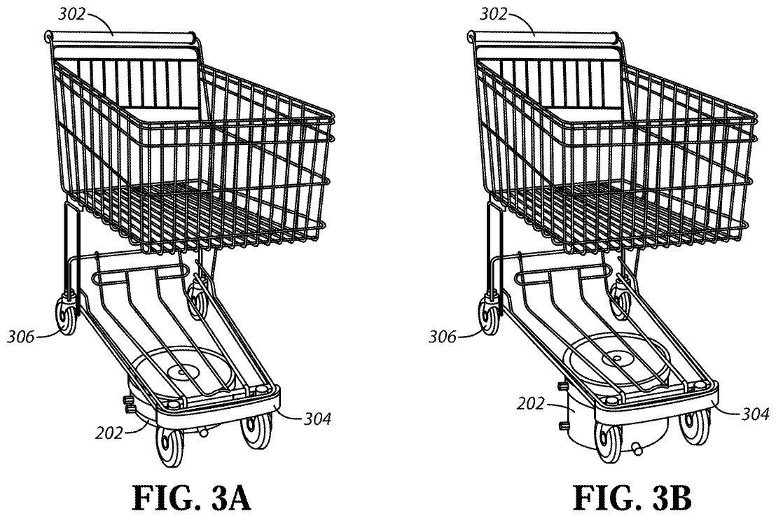

In accordance with some embodiments, a given motorized transport unit 102 detachably connects to a movable item container 104 and is configured to move the movable item container 104 through the shopping facility space under control of the central computer system 106 and/or the user interface unit 114. For example, a motorized transport unit 102 can move to a position underneath a movable item container 104 (such as a shopping cart, a rocket cart, a flatbed cart, or any other mobile basket or platform), align itself with the movable item container 104 (e.g., using sensors) and then raise itself to engage an undersurface of the movable item container 104 and lift a portion of the movable item container 104. Once the motorized transport unit is cooperating with the movable item container 104 (e.g., lifting a portion of the movable item container), the motorized transport unit 102 can continue to move throughout the facility space 101 taking the movable item container 104 with it. In some examples, the motorized transport unit 102 takes the form of the motorized transport unit 202 of FIGS. 2A-3B as it engages and detachably connects to a given movable item container 104. It is understood that in other embodiments, the motorized transport unit 102 may not lift a portion of the movable item container 104, but that it removably latches to, connects to or otherwise attaches to a portion of the movable item container 104 such that the movable item container 104 can be moved by the motorized transport unit 102. For example, the motorized transport unit 102 can connect to a given movable item container using a hook, a mating connector, a magnet, and so on.

In addition to detachably coupling to movable item containers 104 (such as shopping carts), in some embodiments, motorized transport units 102 can move to and engage or connect to an item display module 130 and/or an item storage unit or locker 132. For example, an item display module 130 may take the form of a mobile display rack or shelving unit configured to house and display certain items for sale. It may be desired to position the display module 130 at various locations within the shopping facility 101 at various times. Thus, one or more motorized transport units 102 may move (as controlled by the central computer system 106) underneath the item display module 130, extend upward to lift the module 130 and then move it to the desired location. A storage locker 132 may be a storage device where items for purchase are collected and placed therein for a customer and/or worker to later retrieve. In some embodiments, one or more motorized transport units 102 may be used to move the storage locker to a desired location in the shopping facility 101. Similar to how a motorized transport unit engages a movable item container 104 or item display module 130, one or more motorized transport units 102 may move (as controlled by the central computer system 106) underneath the storage locker 132, extend upward to lift the locker 132 and then move it to the desired location.

FIGS. 2A and 2B illustrate some embodiments of a motorized transport unit 202, similar to the motorized transport unit 102 shown in the system of FIG. 1. In this embodiment, the motorized transport unit 202 takes the form of a disc-shaped robotic device having motorized wheels (not shown), a lower body portion 204 and an upper body portion 206 that fits over at least part of the lower body portion 204. It is noted that in other embodiments, the motorized transport unit may have other shapes and/or configurations, and is not limited to disc-shaped. For example, the motorized transport unit may be cubic, octagonal, triangular, or other shapes, and may be dependent on a movable item container with which the motorized transport unit is intended to cooperate. Also included are guide members 208. In FIG. 2A, the motorized transport unit 202 is shown in a retracted position in which the upper body portion 206 fits over the lower body portion 204 such that the motorized transport unit 202 is in its lowest profile orientation which is generally the preferred orientation for movement when it is unattached to a movable item container 104 for example. In FIG. 2B, the motorized transport unit 202 is shown in an extended position in which the upper body portion 206 is moved upward relative to the lower body portion 204 such that the motorized transport unit 202 is in its highest profile orientation for movement when it is lifting and attaching to a movable item container 104 for example. The mechanism within the motorized transport unit 202 is designed to provide sufficient lifting force to lift the weight of the upper body portion 206 and other objects to be lifted by the motorized transport unit 202, such as movable item containers 104 and items placed within the movable item container, item display modules 130 and items supported by the item display module, and storage lockers 132 and items placed within the storage locker. The guide members 208 are embodied as pegs or shafts that extend horizontally from the both the upper body portion 206 and the lower body portion 204. In some embodiments, these guide members 208 assist docking the motorized transport unit 202 to a docking station 122 or a dispenser 120. In some embodiments, the lower body portion 204 and the upper body portion are capable to moving independently of each other. For example, the upper body portion 206 may be raised and/or rotated relative to the lower body portion 204. That is, one or both of the upper body portion 206 and the lower body portion 204 may move toward/away from the other or rotated relative to the other. In some embodiments, in order to raise the upper body portion 206 relative to the lower body portion 204, the motorized transport unit 202 includes an internal lifting system (e.g., including one or more electric actuators or rotary drives or motors). Numerous examples of such motorized lifting and rotating systems are known in the art. Accordingly, further elaboration in these regards is not provided here for the sake of brevity.

FIGS. 3A and 3B illustrate some embodiments of the motorized transport unit 202 detachably engaging a movable item container embodied as a shopping cart 302. In FIG. 3A, the motorized transport unit 202 is in the orientation of FIG. 2A such that it is retracted and able to move in position underneath a portion of the shopping cart 302. Once the motorized transport unit 202 is in position (e.g., using sensors), as illustrated in FIG. 3B, the motorized transport unit 202 is moved to the extended position of FIG. 2B such that the front portion 304 of the shopping cart is lifted off of the ground by the motorized transport unit 202, with the wheels 306 at the rear of the shopping cart 302 remaining on the ground. In this orientation, the motorized transport unit 202 is able to move the shopping cart 302 throughout the shopping facility. It is noted that in these embodiments, the motorized transport unit 202 does not bear the weight of the entire cart 302 since the rear wheels 306 rest on the floor. It is understood that in some embodiments, the motorized transport unit 202 may be configured to detachably engage other types of movable item containers, such as rocket carts, flatbed carts or other mobile baskets or platforms.

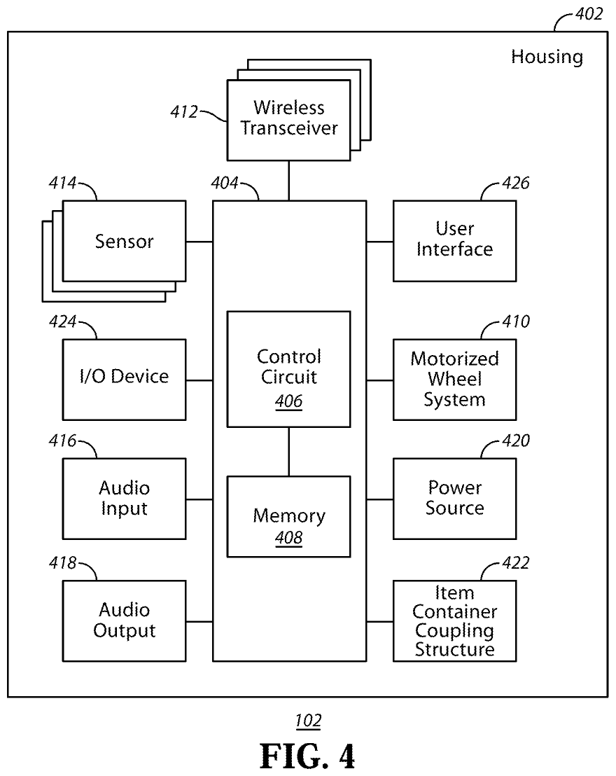

FIG. 4 presents a more detailed example of some embodiments of the motorized transport unit 102 of FIG. 1. In this example, the motorized transport unit 102 has a housing 402 that contains (partially or fully) or at least supports and carries a number of components. These components include a control unit 404 comprising a control circuit 406 that, like the control circuit 108 of the central computer system 106, controls the general operations of the motorized transport unit 102. Accordingly, the control unit 404 also includes a memory 408 coupled to the control circuit 406 and that stores, for example, operating instructions and/or useful data.

The control circuit 406 operably couples to a motorized wheel system 410. This motorized wheel system 410 functions as a locomotion system to permit the motorized transport unit 102 to move within the aforementioned retail or shopping facility 101 (thus, the motorized wheel system 410 may more generically be referred to as a locomotion system). Generally speaking, this motorized wheel system 410 will include at least one drive wheel (i.e., a wheel that rotates (around a horizontal axis) under power to thereby cause the motorized transport unit 102 to move through interaction with, for example, the floor of the shopping facility 101). The motorized wheel system 410 can include any number of rotating wheels and/or other floor-contacting mechanisms as may be desired and/or appropriate to the application setting.

The motorized wheel system 410 also includes a steering mechanism of choice. One simple example in these regards comprises one or more of the aforementioned wheels that can swivel about a vertical axis to thereby cause the moving motorized transport unit 102 to turn as well.

Numerous examples of motorized wheel systems are known in the art. Accordingly, further elaboration in these regards is not provided here for the sake of brevity save to note that the aforementioned control circuit 406 is configured to control the various operating states of the motorized wheel system 410 to thereby control when and how the motorized wheel system 410 operates.

In this illustrative example, the control circuit 406 also operably couples to at least one wireless transceiver 412 that operates according to any known wireless protocol. This wireless transceiver 412 can comprise, for example, a Wi-Fi-compatible and/or Bluetooth-compatible transceiver that can communicate with the aforementioned central computer system 106 via the aforementioned wireless network 124 of the shopping facility 101. So configured the control circuit 406 of the motorized transport unit 102 can provide information to the central computer system 106 and can receive information and/or instructions from the central computer system 106. As one simple example in these regards, the control circuit 406 can receive instructions from the central computer system 106 regarding movement of the motorized transport unit 102.

These teachings will accommodate using any of a wide variety of wireless technologies as desired and/or as may be appropriate in a given application setting. These teachings will also accommodate employing two or more different wireless transceivers 412 if desired.

The control circuit 406 also couples to one or more on-board sensors 414. These teachings will accommodate a wide variety of sensor technologies and form factors. By one approach at least one such sensor 414 can comprise a light sensor or light receiver. When the aforementioned location detection system 116 comprises a plurality of light emitters disposed at particular locations within the shopping facility 101, such a light sensor can provide information that the control circuit 406 and/or the central computer system 106 employs to determine a present location and/or orientation of the motorized transport unit 102.

As another example, such a sensor 414 can comprise a distance measurement unit configured to detect a distance between the motorized transport unit 102 and one or more objects or surfaces around the motorized transport unit 102 (such as an object that lies in a projected path of movement for the motorized transport unit 102 through the shopping facility 101). These teachings will accommodate any of a variety of distance measurement units including optical units and sound/ultrasound units. In one example, a sensor 414 comprises a laser distance sensor device capable of determining a distance to objects in proximity to the sensor. In some embodiments, a sensor 414 comprises an optical based scanning device to sense and read optical patterns in proximity to the sensor, such as bar codes variously located on structures in the shopping facility 101. In some embodiments, a sensor 414 comprises a radio frequency identification (RFID) tag reader capable of reading RFID tags in proximity to the sensor. Such sensors may be useful to determine proximity to nearby objects, avoid collisions, orient the motorized transport unit at a proper alignment orientation to engage a movable item container, and so on.

The foregoing examples are intended to be illustrative and are not intended to convey an exhaustive listing of all possible sensors. Instead, it will be understood that these teachings will accommodate sensing any of a wide variety of circumstances or phenomena to support the operating functionality of the motorized transport unit 102 in a given application setting.

By one optional approach an audio input 416 (such as a microphone) and/or an audio output 418 (such as a speaker) can also operably couple to the control circuit 406. So configured the control circuit 406 can provide a variety of audible sounds to thereby communicate with a user of the motorized transport unit 102, other persons in the vicinity of the motorized transport unit 102, or even other motorized transport units 102 in the area. These audible sounds can include any of a variety of tones and other non-verbal sounds. These audible sounds can also include, in lieu of the foregoing or in combination therewith, pre-recorded or synthesized speech.

The audio input 416, in turn, provides a mechanism whereby, for example, a user provides verbal input to the control circuit 406. That verbal input can comprise, for example, instructions, inquiries, or information. So configured, a user can provide, for example, a question to the motorized transport unit 102 (such as, “Where are the towels?”). The control circuit 406 can cause that verbalized question to be transmitted to the central computer system 106 via the motorized transport unit's wireless transceiver 412. The central computer system 106 can process that verbal input to recognize the speech content and to then determine an appropriate response. That response might comprise, for example, transmitting back to the motorized transport unit 102 specific instructions regarding how to move the motorized transport unit 102 (via the aforementioned motorized wheel system 410) to the location in the shopping facility 101 where the towels are displayed.

In this example the motorized transport unit 102 includes a rechargeable power source 420 such as one or more batteries. The power provided by the rechargeable power source 420 can be made available to whichever components of the motorized transport unit 102 require electrical energy. By one approach the motorized transport unit 102 includes a plug or other electrically conductive interface that the control circuit 406 can utilize to automatically connect to an external source of electrical energy to thereby recharge the rechargeable power source 420.

By one approach the motorized transport unit 102 comprises an integral part of a movable item container 104 such as a grocery cart. As used herein, this reference to “integral” will be understood to refer to a non-temporary combination and joinder that is sufficiently complete so as to consider the combined elements to be as one. Such a joinder can be facilitated in a number of ways including by securing the motorized transport unit housing 402 to the item container using bolts or other threaded fasteners as versus, for example, a clip.

These teachings will also accommodate selectively and temporarily attaching the motorized transport unit 102 to an item container 104. In such a case the motorized transport unit 102 can include a movable item container coupling structure 422. By one approach this movable item container coupling structure 422 operably couples to a control circuit 202 to thereby permit the latter to control, for example, the latched and unlatched states of the movable item container coupling structure 422. So configured, by one approach the control circuit 406 can automatically and selectively move the motorized transport unit 102 (via the motorized wheel system 410) towards a particular item container until the movable item container coupling structure 422 can engage the item container to thereby temporarily physically couple the motorized transport unit 102 to the item container. So latched, the motorized transport unit 102 can then cause the item container to move with the motorized transport unit 102. In embodiments such as illustrated in FIGS. 2A-3B, the movable item container coupling structure 422 includes a lifting system (e.g., including an electric drive or motor) to cause a portion of the body or housing 402 to engage and lift a portion of the item container off of the ground such that the motorized transport unit 102 can carry a portion of the item container. In other embodiments, the movable transport unit latches to a portion of the movable item container without lifting a portion thereof off of the ground.

In either case, by combining the motorized transport unit 102 with an item container, and by controlling movement of the motorized transport unit 102 via the aforementioned central computer system 106, these teachings will facilitate a wide variety of useful ways to assist both customers and associates in a shopping facility setting. For example, the motorized transport unit 102 can be configured to follow a particular customer as they shop within the shopping facility 101. The customer can then place items they intend to purchase into the item container that is associated with the motorized transport unit 102.

In some embodiments, the motorized transport unit 102 includes an input/output (I/O) device 424 that is coupled to the control circuit 406. The I/O device 424 allows an external device to couple to the control unit 404. The function and purpose of connecting devices will depend on the application. In some examples, devices connecting to the I/O device 424 may add functionality to the control unit 404, allow the exporting of data from the control unit 404, allow the diagnosing of the motorized transport unit 102, and so on.

In some embodiments, the motorized transport unit 102 includes a user interface 426 including for example, user inputs and/or user outputs or displays depending on the intended interaction with the user. For example, user inputs could include any input device such as buttons, knobs, switches, touch sensitive surfaces or display screens, and so on. Example user outputs include lights, display screens, and so on. The user interface 426 may work together with or separate from any user interface implemented at a user interface unit 114 (such as a smart phone or tablet device).

The control unit 404 includes a memory 408 coupled to the control circuit 406 and that stores, for example, operating instructions and/or useful data. The control circuit 406 can comprise a fixed-purpose hard-wired platform or can comprise a partially or wholly programmable platform. These architectural options are well known and understood in the art and require no further description here. This control circuit 406 is configured (for example, by using corresponding programming stored in the memory 408 as will be well understood by those skilled in the art) to carry out one or more of the steps, actions, and/or functions described herein. The memory 408 may be integral to the control circuit 406 or can be physically discrete (in whole or in part) from the control circuit 406 as desired. This memory 408 can also be local with respect to the control circuit 406 (where, for example, both share a common circuit board, chassis, power supply, and/or housing) or can be partially or wholly remote with respect to the control circuit 406. This memory 408 can serve, for example, to non-transitorily store the computer instructions that, when executed by the control circuit 406, cause the control circuit 406 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

It is noted that not all components illustrated in FIG. 4 are included in all embodiments of the motorized transport unit 102. That is, some components may be optional depending on the implementation.

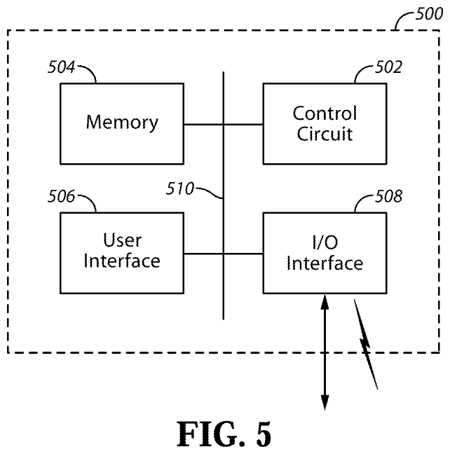

FIG. 5 illustrates a functional block diagram that may generally represent any number of various electronic components of the system 100 that are computer type devices. The computer device 500 includes a control circuit 502, a memory 504, a user interface 506 and an input/output (I/O) interface 508 providing any type of wired and/or wireless connectivity to the computer device 500, all coupled to a communication bus 510 to allow data and signaling to pass therebetween. Generally, the control circuit 502 and the memory 504 may be referred to as a control unit. The control circuit 502, the memory 504, the user interface 506 and the I/O interface 508 may be any of the devices described herein or as understood in the art. The functionality of the computer device 500 will depend on the programming stored in the memory 504. The computer device 500 may represent a high level diagram for one or more of the central computer system 106, the motorized transport unit 102, the user interface unit 114, the location detection system 116, the user interface computer 128, the MTU docking station 122 and the MTU dispenser 120, or any other device or component in the system that is implemented as a computer device.

Additional Features Overview

Referring generally to FIGS. 1-5, the shopping assistance system 100 may implement one or more of several different features depending on the configuration of the system and its components. The following provides a brief description of several additional features that could be implemented by the system. One or more of these features could also be implemented in other systems separate from embodiments of the system. This is not meant to be an exhaustive description of all features and not meant to be an exhaustive description of the details of any one of the features. Further details with regards to one or more features beyond this overview may be provided herein.

Tagalong Steering: This feature allows a given motorized transport unit 102 to lead or follow a user (e.g., a customer and/or a worker) throughout the shopping facility 101. For example, the central computer system 106 uses the location detection system 116 to determine the location of the motorized transport unit 102. For example, LED smart lights (e.g., the ByteLight system) of the location detection system 116 transmit a location number to smart devices which are with the customer (e.g., user interface units 114), and/or on the item container 104/motorized transport unit 102. The central computer system 106 receives the LED location numbers received by the smart devices through the wireless network 124. Using this information, in some embodiments, the central computer system 106 uses a grid placed upon a 2D CAD map and 3D point cloud model (e.g., from the databases 126) to direct, track, and plot paths for the other devices. Using the grid, the motorized transport unit 102 can drive a movable item container 104 in a straight path rather than zigzagging around the facility. As the user moves from one grid to another, the motorized transport unit 102 drives the container 104 from one grid to the other. In some embodiments, as the user moves towards the motorized transport unit, it stays still until the customer moves beyond an adjoining grid.

Detecting Objects: In some embodiments, motorized transport units 102 detect objects through several sensors mounted on motorized transport unit 102, through independent cameras (e.g., video cameras 118), through sensors of a corresponding movable item container 104, and through communications with the central computer system 106. In some embodiments, with semi-autonomous capabilities, the motorized transport unit 102 will attempt to avoid obstacles, and if unable to avoid, it will notify the central computer system 106 of an exception condition. In some embodiments, using sensors 414 (such as distance measurement units, e.g., laser or other optical-based distance measurement sensors), the motorized transport unit 102 detects obstacles in its path, and will move to avoid, or stop until the obstacle is clear.

Visual Remote Steering: This feature enables movement and/or operation of a motorized transport unit 102 to be controlled by a user on-site, off-site, or anywhere in the world. This is due to the architecture of some embodiments where the central computer system 106 outputs the control signals to the motorized transport unit 102. These controls signals could have originated at any device in communication with the central computer system 106. For example, the movement signals sent to the motorized transport unit 102 may be movement instructions determined by the central computer system 106; commands received at a user interface unit 114 from a user; and commands received at the central computer system 106 from a remote user not located at the shopping facility space.

Determining Location: Similar to that described above, this feature enables the central computer system 106 to determine the location of devices in the shopping facility 101. For example, the central computer system 106 maps received LED light transmissions, Bluetooth low energy radio signals or audio signals (or other received signals encoded with location data) to a 2D map of the shopping facility. Objects within the area of the shopping facility are also mapped and associated with those transmissions. Using this information, the central computer system 106 can determine the location of devices such as motorized transport units.

Digital Physical Map Integration: In some embodiments, the system 100 is capable of integrating 2D and 3D maps of the shopping facility with physical locations of objects and workers. Once the central computer system 106 maps all objects to specific locations using algorithms, measurements and LED geo-location, for example, grids are applied which sections off the maps into access ways and blocked sections. Motorized transport units 102 use these grids for navigation and recognition. In some cases, grids are applied to 2D horizontal maps along with 3D models. In some cases, grids start at a higher unit level and then can be broken down into smaller units of measure by the central computer system 106 when needed to provide more accuracy.

Calling a Motorized Transport Unit: This feature provides multiple methods to request and schedule a motorized transport unit 102 for assistance in the shopping facility. In some embodiments, users can request use of a motorized transport unit 102 through the user interface unit 114. The central computer system 106 can check to see if there is an available motorized transport unit. Once assigned to a given user, other users will not be able to control the already assigned transport unit. Workers, such as store associates, may also reserve multiple motorized transport units in order to accomplish a coordinated large job.

Locker Delivery: In some embodiments, one or more motorized transport units 102 may be used to pick, pack, and deliver items to a particular storage locker 132. The motorized transport units 102 can couple to and move the storage locker to a desired location. In some embodiments, once delivered, the requestor will be notified that the items are ready to be picked up, and will be provided the locker location and locker security code key.

Route Optimization: In some embodiments, the central computer system automatically generates a travel route for one or more motorized transport units through the shopping facility space. In some embodiments, this route is based on one or more of a user provided list of items entered by the user via a user interface unit 114; user selected route preferences entered by the user via the user interface unit 114; user profile data received from a user information database (e.g., from one of databases 126); and product availability information from a retail inventory database (e.g., from one of databases 126). In some cases, the route intends to minimize the time it takes to get through the facility, and in some cases, may route the shopper to the least busy checkout area. Frequently, there will be multiple possible optimum routes. The route chosen may take the user by things the user is more likely to purchase (in case they forgot something), and away from things they are not likely to buy (to avoid embarrassment). That is, routing a customer through sporting goods, women's lingerie, baby food, or feminine products, who has never purchased such products based on past customer behavior would be non-productive, and potentially embarrassing to the customer. In some cases, a route may be determined from multiple possible routes based on past shopping behavior, e.g., if the customer typically buys a cold Diet Coke product, children's shoes or power tools, this information would be used to add weight to the best alternative routes, and determine the route accordingly.

Store Facing Features: In some embodiments, these features enable functions to support workers in performing store functions. For example, the system can assist workers to know what products and items are on the shelves and which ones need attention. For example, using 3D scanning and point cloud measurements, the central computer system can determine where products are supposed to be, enabling workers to be alerted to facing or zoning of issues along with potential inventory issues.

Phone Home: This feature allows users in a shopping facility 101 to be able to contact remote users who are not at the shopping facility 101 and include them in the shopping experience. For example, the user interface unit 114 may allow the user to place a voice call, a video call, or send a text message. With video call capabilities, a remote person can virtually accompany an in-store shopper, visually sharing the shopping experience while seeing and talking with the shopper. One or more remote shoppers may join the experience.

Returns: In some embodiments, the central computer system 106 can task a motorized transport unit 102 to keep the returns area clear of returned merchandise. For example, the transport unit may be instructed to move a cart from the returns area to a different department or area. Such commands may be initiated from video analytics (the central computer system analyzing camera footage showing a cart full), from an associate command (digital or verbal), or on a schedule, as other priority tasks allow. The motorized transport unit 102 can first bring an empty cart to the returns area, prior to removing a full one.

Bring a Container: One or more motorized transport units can retrieve a movable item container 104 (such as a shopping cart) to use. For example, upon a customer or worker request, the motorized transport unit 102 can re-position one or more item containers 104 from one location to another. In some cases, the system instructs the motorized transport unit where to obtain an empty item container for use. For example, the system can recognize an empty and idle item container that has been abandoned or instruct that one be retrieved from a cart storage area. In some cases, the call to retrieve an item container may be initiated through a call button placed throughout the facility, or through the interface of a user interface unit 114.

Respond to Voice Commands: In some cases, control of a given motorized transport unit is implemented through the acceptance of voice commands. For example, the user may speak voice commands to the motorized transport unit 102 itself and/or to the user interface unit 114. In some embodiments, a voice print is used to authorize use of a motorized transport unit 102 to allow voice commands from single user at a time.

Retrieve Abandoned Item Containers: This feature allows the central computer system to track movement of movable item containers in and around the area of the shopping facility 101, including both the sale floor areas and the back-room areas. For example, using visual recognition through store cameras 118 or through user interface units 114, the central computer system 106 can identify abandoned and out-of-place movable item containers. In some cases, each movable item container has a transmitter or smart device which will send a unique identifier to facilitate tracking or other tasks and its position using LED geo-location identification. Using LED geo-location identification with the Determining Location feature through smart devices on each cart, the central computer system 106 can determine the length of time a movable item container 104 is stationary.

Stocker Assistance: This feature allows the central computer system to track movement of merchandise flow into and around the back-room areas. For example, using visual recognition and captured images, the central computer system 106 can determine if carts are loaded or not for moving merchandise between the back room areas and the sale floor areas. Tasks or alerts may be sent to workers to assign tasks.

Self-Docking: Motorized transport units 102 will run low or out of power when used. Before this happens, the motorized transport units 102 need to recharge to stay in service. According to this feature, motorized transport units 102 will self-dock and recharge (e.g., at a MTU docking station 122) to stay at maximum efficiency, when not in use. When use is completed, the motorized transport unit 102 will return to a docking station 122. In some cases, if the power is running low during use, a replacement motorized transport unit can be assigned to move into position and replace the motorized transport unit with low power. The transition from one unit to the next can be seamless to the user.

Item Container Retrieval: With this feature, the central computer system 106 can cause multiple motorized transport units 102 to retrieve abandoned item containers from exterior areas such as parking lots. For example, multiple motorized transport units are loaded into a movable dispenser, e.g., the motorized transport units are vertically stacked in the dispenser. The dispenser is moved to the exterior area and the transport units are dispensed. Based on video analytics, it is determined which item containers 104 are abandoned and for how long. A transport unit will attach to an abandoned cart and return it to a storage bay.

Motorized Transport Unit Dispenser: This feature provides the movable dispenser that contains and moves a group of motorized transport units to a given area (e.g., an exterior area such as a parking lot) to be dispensed for use. For example, motorized transport units can be moved to the parking lot to retrieve abandoned item containers 104. In some cases, the interior of the dispenser includes helically wound guide rails that mate with the guide member 208 to allow the motorized transport units to be guided to a position to be dispensed.

Specialized Module Retrieval: This feature allows the system 100 to track movement of merchandise flow into and around the sales floor areas and the back-room areas including special modules that may be needed to move to the sales floor. For example, using video analytics, the system can determine if a modular unit it loaded or empty. Such modular units may house items that are of seasonal or temporary use on the sales floor. For example, when it is raining, it is useful to move a module unit displaying umbrellas from a back room area (or a lesser accessed area of the sales floor) to a desired area of the sales floor area.

Authentication: This feature uses a voice imprint with an attention code/word to authenticate a user to a given motorized transport unit. One motorized transport unit can be swapped for another using this authentication. For example, a token is used during the session with the user. The token is a unique identifier for the session which is dropped once the session is ended. A logical token may be a session id used by the application of the user interface unit 114 to establish the session id when user logs on and when deciding to do use the system 100. In some embodiments, communications throughout the session are encrypted using SSL or other methods at transport level.

Further Details of Some Embodiments

In accordance with some embodiments, further details are now provided for one or more of these and other features. Some embodiments provide remote steering allowing a worker of the shopping facility to override one or more actions, motions, control or otherwise direct movement of one or more motorized transport units. An authorized user can override a motorized transport unit, including when the motorized transport unit is being directed to support a customer, when it is performing a task assigned by the central computer system, and other such conditions. Typically the override supersedes operating limits of the motorized transport units, such as but not limited to other task priorities, instructions, certain sensors, geographical boundaries, predetermined paths, other users, and the like. In some embodiments, a shopping facility worker performing the override does not need to be physically present, and can further receive images and/or video from one or more cameras of the motorized transport unit and/or the shopping facility cameras to see the area proximate to and in some instances surrounding the motorized transport unit. During the override, the authorized worker may direct the motorized transport unit by submitting instructions and/or requests through the central computer system. The central computer system typically continues to maintain control over the motorized transport unit and issue relevant instructions to be performed by the motorized transport unit to cause the motorized transport unit to make movements and perform tasks based on instructions or requests received from the authorized worker. As such, the override does not take control away from the central computer system, but enables the worker to direct the motorized transport unit through the central computer system. Directions continue to be processed by the central computer system. Further, in some implementation, the central computer system logs instructions received from a worker, instructions or commands issued to the motorized transport unit, location and/or information corresponding to the motorized transport unit, and/or other such information. Further still, the central computer system in some embodiments is configured to allow an override of an override by a worker with a higher authority.

FIG. 6 shows a simplified flow diagram of an exemplary process 600 of implementing an override of a motorized transport unit, in accordance with some embodiments. In step 602, one or more override commands are received from a shopping facility worker associated with the shopping facility, and/or one or more instructions following an override command are received from the worker. Typically, the override command is configured to cause a motorized transport unit to implement one or more actions or tasks that may exceed one or more operating limits or conditions. Such operating limits can include, but are not limited to, a current task being performed, task limits or restrictions (e.g., a motorized transport unit may be assigned to implement a restricted set of one or more tasks), one or more boundaries or other geographical limits imposed on the motorized transport unit, one or more sensor thresholds, or other such operating limits, or combinations of two or more of such limits. As such, in some embodiments, the central computer system identifies that the override command will cause the motorized transport unit to exceed one or more operating limits of the motorized transport unit.

In some implementations, the override command identifies a specific motorized transport unit that is to be overridden (e.g., through a name, identification number, scan of a machine readable code corresponding to and/or on the motorized transport unit, or the like). In other instances, the override command is a request that a motorized transport unit perform a task and the central computer system identifies a relevant motorized transport unit and implements the override of the selected motorized transport unit (e.g., based on one or more of: a location of the task to be performed, a location of the motorized transport unit, a location of the motorized transport unit relative to the requested task, the capabilities of a motorized transport unit, battery power level, task being performed that is to be overridden, other such factors, or a combination of two or more of such factors). Still further, the override may cause an override of more than one motorized transport unit, such as when it is determined that multiple motorized transport units may be needed to perform the task (e.g., to move an object that is expected to exceed a weight capacity of a single motorized transport unit, perform multiple different instructions to implement the task, and the like).

In step 604, the central computer system confirms a valid authorization of the worker to override one or more operating limits of the first motorized transport unit. In some instances, not every worker at a shopping facility is authorized to override a motorized transport unit. Further, customers are often not authorized to override a motorized transport unit. Accordingly, in some embodiments the worker attempting to override the motorized transport unit provides an authorization to the central computer system (e.g., password, worker identifier, an RFID associated with the worker (e.g., from a name tag), or the like), and/or the central computer system acquires an authorization (e.g., based on the worker logging into the central computer system, a user interface unit, or the like; receiving an user interface unit identifier from a user interface unit identifier associated with the worker; or the like).

In some embodiments, the central computer system maintains a database of workers and their corresponding authorization to override one or more motorized transport units. The authorization may be limited to certain types of motorized transport units, limited to perform certain types of tasks, limited to certain times of the day and/or night, limited to overriding motorized transport units performing certain tasks while not being able to override motorized transport units performing other tasks, or other such limits, or a combination of two or more of such limits. Still further, the authorization may further allow a worker to override a customer, one or more other workers use of a motorized transport unit, and/or override one or more workers that have implemented an override of a motorized transport unit.

In step 606, the central computer system overrides the one or more motorized transport units and the one or more operating limits with one or more identified relevant instructions or commands to implement the one or more actions, and communicates the one or more instructions to the one or more motorized transport units configured to cause the one or more motorized transport units to implement the one or more actions in accordance with the override command. Again, the override can include the override of a current task being performed by the motorized transport unit. For example, the motorized transport units are often configured to cooperate with a movable item container to move the movable item container through the shopping facility, such as when helping a customer during a shopping experience. One or more issues may arise when a shopping facility worker may need to override the task of helping a customer. As such, the worker can implement the override to take over from the customer and issue one or more commands or requests to the central computer system. The central computer system, upon confirming the worker's authority to implement the override, identifies relevant commands to implement the one or more worker requests and communicates those commands to one or more motorized transport units in implementing the override. In some instances when an override is activated, the motorized transport unit may issue a notification, such as an audible notification (e.g., “please excuse the disruption in service”, an alarm, etc.), display a notice on the user interface, or other notification. Similarly, the central computer system may additionally or alternatively issue a notification to one or more other devices, such as one or more user interface units, movable item containers, etc. The central computer system may implement other actions in response to the override, such as instructing a second motorized transport unit to replace the overridden motorized transport unit.

The override may additional or alternatively override one or more sensors of the motorized transport unit, a movable item container, the shopping facility and/or other sensors. In some embodiments, the central computer system identifies one or more sensors on the motorized transport unit that detect one or more conditions confirming that at least one of the one or more operating limits are exceeded. Depending on the override task being performed, the central computer system can be configured to disregard sensor information detected by the identified one or more sensors, which can include one or more thresholds being met or exceeded, and received from the first motorized transport unit or other devices (e.g., movable item container, user interface unit, video camera of the shopping facility, etc.). The central computer system can instead continue the override and continue to communicate one or more instructions in contradiction to the sensor information and/or threshold conditions.

For example, some motorized transport units may be configured with a bump sensor that is activated in response to detecting that the motorized transport unit has contacted another object. Accordingly, one or more limits may be set that affect the movement and/or operation of the motorized transport unit in response to the bump sensor detecting contact with another object. However, the implementation of the override may disregard the bump sensor information and/or a worker may override this bump sensor when the worker is utilizing the motorized transport unit, such as using the motorized transport unit to push an object, maintain a position of an object, or the like. Similarly, some motorized transport units have distance sensors that measure one or more distances between the motorized transport unit and external objects. One or more distance thresholds may be specified in association with the distance sensors to be activated when the motorized transport unit gets too close to an object. The override, however, may intend to move the motorized transport unit close to the object and/or to contact an object. Thus, the override can disregard the distance sensor, distance sensor information, and/or distance sensor thresholds. In some instances, the sensors, thresholds and/or other limits that can be overridden may be limited based on an authority and/or authority level of the worker or other individual or system requesting the override. As such, the central computer system can disregard and/or override substantially any sensor when the worker has sufficient override authority.

In some embodiments, one or more of the operating limits that may be overridden may include one or more geographic boundary limits that the first motorized transport unit is restricted from passing. For example, in some implementations, one or more boundary limits may be established to prevent the motorized transport units from entering an area that may be detrimental to the motorized transport unit, an area where customers are not permitted, traveling too far from the shopping facility, areas where cameras are typically not desirable or permitted (e.g., bathrooms), and other such areas. Accordingly, one or more geographic boundary limits may be applied to one or more motorized transport units that limit or prevent the motorized transport unit from entering or going beyond those boundaries. The override, however, may allow one or more of the boundary limits to be crossed. As such, the central computer system in communicating the override instructions can communicate one or more instructions that override the restriction of one or more boundary limits and cause the motorized transport unit to travel beyond or outside the boundary limit.

As introduced above, in some implementations, the override of one or more limits may include overriding the operation of the motorized transport unit helping a customer. The central computer system can identify that the override command will cause an override of a customer that is actively associated with the motorized transport unit at the time the override command is received. The worker's authorization is confirmed prior to allowing an override. The override may be initiated in response to the worker detecting that the customer is abusing the motorized transport unit, attempting to get the motorized transport unit to take unauthorized actions, interfering with the motorized transport unit to effectively operate, an emergency situation, and other such situations. Accordingly, when the override of the one or more operating limits includes overriding one or more instructions intended to implement actions to support the use of the motorized transport by the customer, the override can in some embodiments include the override of a customer and inhibit control of the motorized transport unit in accordance with a shopping experience by the customer. This override of the customer can include overriding customers commands, overriding customer requests, overriding a determined route of travel of the motorized transport unit (e.g., based on a shopping list or desired product), and the like.

Similarly, in some instances, a first shopping facility worker may override the use of a motorized transport unit by a second shopping facility worker. In response to detecting a request by the first worker to implement an override, the central computer system may identify that the override command will cause an override of the second worker that is currently associated with the motorized transport unit in performing a task and/or who has overridden the operation of the motorized transport unit. Prior to allowing the override, the central computer system typically evaluates the authorizations of the first and second workers. In some instances, the central computer system confirms that the first worker has a higher authorization priority than the second worker before allowing the first worker to override the second worker. In other instances, a priority of tasks may be evaluated in determining whether to authorize the override (e.g., the task intended to be implemented by the first worker has a higher priority than the task being performed by the second worker, a priority level of the task intended to be implemented is greater than a threshold higher than the priority level of the task being performed, etc.). In other embodiments, the central computer system may attempt to acquire authorization from the second worker by notifying the second worker of the first worker's requested override, and asking the second worker (e.g., through the user interface of the motorized transport unit, a user interface unit, etc.) to release control and/or allow the override of the motorized transport unit. Once the central computer system confirms authorization and/or determines that the override of the second worker should be implemented, the central computer system may in some implementations notify the second worker of the override. The central computer system in overriding of the one or more operating limits can be further configured to override one or more override commands received from the second worker and inhibit control of the motorized transport unit by the second worker. This override of another worker may be advantageous in numerous situations, such as when a worker is abusing or incorrectly using a motorized transport unit, when a higher priority task needs to be performed, in emergency conditions, and the like.

In some applications, the central computer system restricts an override to a single worker. As such, some embodiments provide a hierarchy of authority with respect to the overriding of a motorized transport unit. This hierarchy may allow a first worker to override a second worker utilizing the motorized transport unit, even when the second worker has initiated an override of the motorized transport unit. In some embodiments, one or more databases, tables or the like are maintained that identify workers authorized to implement an override and a relative priority or hierarchy of the override authority of different workers. As such, a worker with the highest authority can control the override and direct the motorized transport unit. The central computer system maintains control over the motorized transport unit while receiving instructions from the worker. For example, a hierarchy of authority, in increasing authority, may be defined as line associate, customer service specialist, assistant manager, manager, and executive. It some implementations, multiple workers may cooperatively implement an override. In such situations, however, the central computer system may follow the hierarchy when conflicting instructions are received and implement instructions from the worker with the highest authority.

Further, the hierarchy may further establish authority to perform some override tasks while limiting or preventing some tasks. For example, a worker with a low override authority may not be able to direct the motorized transport unit to cross one or more boundary within the shopping facility, while a worker with a higher authority may be capable of overriding some or all boundaries. As such, the central computer system in implementing one or more requests or commands from a worker maintains control over the motorized transport unit and can restrict the operation of the motorized transport unit and/or prevent one or more instructions from being communicated to the overridden motorized transport unit when the worker requesting the action does not have the authority to implement the requested action. The central computer system may notify the worker and inform her/him that she/he does not have sufficient authority to implement the requested override action or task.

Further, some embodiments provide a hierarchy of motorized transport units. In some implementations, an overridden motorized transport unit is assigned a high or highest authority over other motorized transport units (and potentially over at least some other activities in the shopping facility). The overridden motorized transport unit takes precedent over other motorized transport units in control by the central computer system. The central computer system choreographs the movement of the motorized transport units, and can prevent collisions. In some embodiments, the central computer system, when implementing an override, causes other motorized transport units to halt and/or move out of the path of an overridden motorized transport unit. Further, the central computer system typically tracks the motorized transport units in a shopping facility and attempts to optimize their routes or paths. When a motorized transport unit is overridden the routes of other motorized transport units may be modified to clear a path for the overridden motorized transport unit, even when the modified routes are not an optimized route.

In some applications, the override of the one or more limits may include causing the motorized transport unit to travel to and/or through an area that a motorized transport unit has not previously traveled, an area that has not be mapped, an area where route instructions have not previously been determined, an area where changes in placement of objects has occurred, and the like. Similarly, the task attempting to be performed by the motorized transport unit may be a task that has not previously been performed, a task for which the motorized transport unit is not preconfigured to perform, or other such conditions. Accordingly, it may be beneficial to record the one or more override commands received from the overriding worker, the instructions communicated to the motorized transport unit to implement the commands, the actual movements of the motorized transport unit, functions performed by the motorized transport unit in implementing the override, sensor information obtained while performing the override, and/or other such information. The recorded information may then be subsequently used should a motorized transport unit need to enter the same area in the future, the same or a similar task need to be performed in the future, and the like.

As such, in some embodiments, the central computer system may identify that there is not a predefined route of travel for the motorized transport unit to follow to implement one or more override commands, to move to an intended destination, to implement the intended task, and the like. The central computer system may record the one or more override commands along with one or more subsequent override commands and movement of the motorized transport unit defining a new route in implementing one or more actions and/or tasks. The recording may, in some instances, be initiated in response to identifying the lack of predefined or previously recorded sequence of instructions, movements, route, functions or the like. Similarly, the recording may, in some instances, be initiated in response to identifying the motorized transport unit is entering an area that is not mapped, an area where a motorized transport unit has not previously entered, is traveling a route the motorized transport unit has not previously traveled, performing a task for which the motorized transport unit is not preconfigured, and the like. The central computer system may use the recorded information to implement subsequent overrides and/or control the movement of a motorized transport unit.

The override commands and/or authorization can be provided by the shopping facility worker through the motorized transport unit, a user interface unit, a user interface of the central computer system, a user interface computer 128, or other such device. Further, the commands to implement the actions while in an override mode can be provided through the motorized transport unit, a user interface unit, a user interface of the central computer system, a user interface computer 128, or other such device. In some embodiments, the worker initiating the override and directing the motorized transport unit may use a voice imprint command with a confirmation command that was previously set up in association with an authorization and/or authorized priority level. Further, the worker may use a user interface unit to enter one or more command, such as through a software application (APP) implemented on the user interface unit. The user interface unit may allow the user to enter commands or instructions, such as verbal requests, the selection of one or more options (forward, backward, stop, left, right, left at 45 degrees, forward a predefined distance), selection of one or more arrow options or buttons, a displayed or physical joystick, the movement of a mouse or movement on a touch screen or pad, or other such controls. Similarly, speed of movements may be controlled, such as based on an amount of pressure applied, duration an option is held, a selection of a speed, and the like. In some embodiments, movement may be made based on selections (e.g., dragging a finger along a touchscreen) relative to a displayed mapping. Information about movements and/or actions implemented by the motorized transport unit can be provided back to the worker, such as through video from the motorized transport unit, video from shopping facility cameras, sensor information, animation on a mapping, and the like. The feedback information allows the worker greater control over the movement of the motorized transport unit.

In some embodiments, the movements of the motorized transport unit are precisely and rigidly implemented while in the override mode. This may be particularly critical in areas where previous movement routes have not been established, conditions of the environment in which the motorized transport unit is operating can be hazardous to the motorized transport unit, mapping of the area is unavailable or limited, changes to the positioning of objects has occurred (e.g., by workers, customers, or natural events, such as earthquake, tornado, fire, etc.), and other such instances. For example, speed of movement of the motorized transport unit may be restricted during certain conditions while in the override mode. The restriction of speed may be selected by the worker or activated by the central computer system, which may identify conditions when such speed restrictions are to be implemented (e.g., based on information from outside sources (e.g., emergency alerts, access by emergency responders, etc.), detected through evaluation of the shopping facility (e.g., disruption of products through some or all of the shopping facility, etc.), and the like). Similarly, the distance moved in response to a command may be limited and/or restricted. The amount of restriction on speed, distance of travel, and the like, may be dependent on conditions and may increase or decrease overtime (e.g., normal movements are allowed during override while the motorized transport unit is in a mapped area, but restrictions are applied as the motorized transport unit moves into certain areas, and may be increased or decreased as the motorized transport unit moves through and/or out of the areas).

Typically, while the motorized transport unit is in an override mode, other motorized transport units continue to operate normally. In some embodiments, however, the central computer system further restricts or prevents actions of one or more other motorized transport units while a motorized transport unit is in an override mode. For example, the central computer system may identify one or more motorized transport units that are proximate to and/or within a threshold distance from the motorized transport unit being overridden, and restrict or prevent movement or actions of those other motorized transport units to avoid interfering with the overridden motorized transport unit. This can be of particular importance when the movements of the motorized transport unit during override may deviate from typical movements or routes, and/or may be unpredictable.

Further, in some embodiments, the motorized transport unit locks out one or more tasks the motorized transport unit is typically configured to perform while implementing the one or more override actions that cause the motorized transport unit to exceed the one or more operating limits. As such, the motorized transport unit can be prevented from performing the one or more locked out tasks. In some embodiments, the central computer system communicates the lockout instructions. In other instances, upon activation of the override, the control circuit 405 can obtain local instructions and implement the lock out. Further, the central computer system can be locked out of implementing one or more tasks with respect to the motorized transport unit while in the override mode. The lock out of one or more tasks can avoid inadvertent interference, and can reduce processing at the motorized transport unit and/or the central computer system.

The worker implementing the override can submit requests and/or commands to the central computer system to cause the motorized transport unit to implement one or more actions or tasks. Again, the navigation of the one or more overridden motorized transport units can be through a joystick, remote control, voice while visually directing the motorized transport, via a follow me method where the motorized transport unit is issued instructions to cause it to follow the worker or other individual that has been identified by and/or to the central computer system, follow another motorized transport unit, follow a beacon, follow a user interface unit, selecting of one or more options displayed on a touch screen, and the like. For example, when using a joystick, the joystick indicates a direction to the central computer system that in turn communicates instructions to move the motorized transport unit or otherwise cause the motorized transport unit to implement one or more actions or tasks. In some instances, the movement instructions cause the motorized transport unit to move according to a grid section within a navigation mapping of the shopping facility. In some embodiments, when the motorized transport unit is off the grid of the mapping, the central computer system issues move instructions to the motorized transport unit consistent with requests by the worker (e.g., in the direction the joystick indicates by). Again, the movements in some instances may be very precise, such as movements in increments of one or more centimeters or inches. In some embodiments, the worker may specify the increments, while in other instances the central computer system may select the increments based on one or more factors, such as congestion of an area (congestion of moving and non-moving objects), environmental conditions (e.g., wet, dirty, fire, emergency, etc.), location, and the like. Further, the central computer system may identify one or more sensors to be overridden and/or a worker may identify one or more sensors to be overridden. In some instances, the sensor overrides from a worker are considered suggestions, while in other instances may be mandatory (e.g., based on authority level, condition, task being performed, or the like). For example, in the case of an override of one or more sensors, the worker may wish to bump and push an object with the motorized transport unit. Accordingly, the worker may notify the central computer system that she/he intends to direct the motorized transport unit to bump into an object and continue to push that object, and thus the bump sensor (and potentially a distance sensor) should be ignored and overridden.

In some instances, one or more workers may issue overrides to multiple or all motorized transport units that the worker has the authority to override. This may be to organize a large movement of motorized transport units for a task, to return multiple or all the motorized transport units to one or more docking stations, to stop multiple or all motorized transport units, or other such instances. In some instances, the worker authority may additionally indicate whether the worker has the authority to override more than a single motorized transport unit, how many of the motorized transport units may be overridden, what actions and/or tasks the worker can direct multiple motorized transport units to perform, and the like.

Typically, while the override is in place, the central computer system takes that motorized transport unit out of available status and/or designates the motorized transport unit as unavailable for one or more other tasks (e.g., helping a customer). Further, the central computer system may further consider any tasks and/or actions the motorized transport unit was performing and/or expected to perform. The central computer system can determine whether one or more of these tasks or actions should be reassigned to one or more other motorized transport units, and identify one or more motorized transport units to receive the reassigned tasks. In some instances, the worker may request that the actions and/or tasks be reassigned. In some embodiments, the worker can cancel all assigned tasks or reassign one or more tasks to other motorized transport units.

When the shopping facility worker is finished with the override, the worker typically releases the motorized transport unit. The central computer system can then instruct the motorized transport unit to continue with any remaining tasks assigned to that motorized transport unit, reassign the motorized transport unit to one or more tasks, or cause the motorized transport unit to return to a docking station. The central computer system typically further updates a status of the motorized transport unit to an available status when appropriate.

Shopping facility workers may implement an override for any number of reasons. For example, a worker may override a motorized transport unit being misused by a customer or another worker; a worker needs the motorized transport unit to go beyond set boundaries; a worker would like the motorized transport unit to travel down a new path that is not currently on a shopping facility grid mapping; a manager overrides another worker using a motorized transport unit; a worker is attempting to get a motorized transport unit unstuck in a situation that the central computer system may not be able to correct or may take longer than is desirable; direct the motorized transport unit when the central computer system is unable to figure out how to avoid an object; multiple motorized transport units are going to be used for a large or heavy tasks which cannot be solved by one motorized transport unit; a worker and/or emergency response team may want to direct a motorized transport unit to go into a situation that might be harmful to humans; a worker may direct a motorized transport unit to follow or confront a potential shoplifter, which may allow the camera of the motorized transport unit to capture evidence of the shoplifting, will keep the shopping facility worker away from potential danger of a shoplifter, etc.; to perform a task when a worker is unavailable (e.g., directing customers away from a spill until a worker can arrive to clean the spill, approach a lost child and stay with the child until a worker can be directed to the child, etc.); have the motorized transport unit perform a task in the rain or other adverse weather (e.g., bringing out a movable item container to a customer or other person that needs one); perform tasks for which a motorized transport unit has not been programmed such as cleaning the parking lot of some trash or debris; program navigational paths for other motorized transport units and/or setting advertising paths in front of a shopping facility (e.g., on a very hot day); monitor compliance issues by being remotely steered to locations and capturing compliance on video; remotely steered to capture data (e.g., counting, measuring, comparing, etc.); and other such situations.

The override can be implemented through a user interface computer 128, user interface unit 114 (which may be operating at the shopping facility or remote from the shopping facility), the motorized transport unit being overridden or another motorized transport unit, a user interface of a movable item container, and the like. For example, a motorized transport unit may be overridden and a worker may perform remote steering from a user interface unit or other system in order to submit instructions to the central computer system allowing the worker to direct the movements of the motorized transport unit. Often the motorized transport unit includes one or more cameras that provide one or more views (e.g., forward and backward) or even 360 degree view about the motorized transport unit allowing a remote worker to view and issue instructions to steer the motorized transport unit in any direction, and watch the effects (e.g., what is being towed, watch contact with another object, watch as the motorized transport unit goes beyond boundaries, etc.).

While pulling objects such as a movable item container, the worker may want the ability to see the movable item container or may choose to use an assisted remote steering mode. In other instances, while implementing an assisted remote steering mode, a worker may issue a simplified remote steering command directing the motorized transport unit to advance or backup, which may include movement along pre-determined navigational paths, without the need to continuously view the cart. This allows a worker to focus on other activities. Assisted remote steering can provide a semi-eyes-free mode for remotely steering. When addressing a fault condition, being able to remotely control the motorized transport unit with minimal on-board resources may be advantage.

In some embodiments, the central computer system further allows an override of an operation and/or the instructions being and/or intended to be performed by a motorized transport unit. For example, there are instances when navigation, tasks, and activities of a motorized transport unit should and/or need to be overridden. These situations include, but are not limited to, navigating and recording a new potential path that has not yet been defined or created through the central computer system; situations where geographic boundaries or limits imposed on the motorized transport unit might need to be crossed; situations where manual control is needed (e.g., central computer system cannot identify an effective way to avoid an object); implementing an action not typically implemented by the motorized transport unit; and other such situations. Further, some embodiments are configured to override activities, sensors, set paths, and the like. The override can be implemented directly at the motorized transport unit, through a user interface unit, or other system or device capable of communicating with the central computer system (e.g., through an overriding application).

Further, in some embodiments, the override includes a remote steering. A shopping facility worker associated with a shopping facility may be granted authorization to override instructions and/or commands to a motorized transport unit, which can include overriding instructions that are intended to support a shopping experience of a customer that may have been directing the motorized transport unit. Similarly, the override may include overriding a task assigned by the central computer system to the motorized transport unit. In some implementations, the override can supersede other task priorities, instructions, certain sensors, geographical boundaries, predetermined paths, other users, and other such operating limits that may be imposed. In some embodiments, the worker performing the override does not necessarily have to be physically present at motorized transport unit or even at the shopping facility. In some implementations, one or more cameras of one or more motorized transport units, movable item containers, user interface units, the shopping facility, and/or other cameras can use to display video and/or images to the worker to visually see an area proximate to and/or surrounding the motorized transport unit that is being overridden. The central computer system maintains direct control over the motorized transport unit during the override, and may receive input from the authorized worker in identifying commands and/or instructions to communicate to the motorized transport unit. Accordingly, in some embodiments, the override enables the worker to at least in part direct the motorized transport unit through the central computer system. Control over the motorized transport unit continues to be processed through the central computer system. Further, in some applications, the central computer system may log and monitor the movements and/or other actions of the motorized. Some embodiments further allow a subsequent override of an override, such as by someone with a higher authority.

In some embodiments, apparatuses and methods are provided herein useful to override the operation of a motorized transport unit. This can include overriding to cause the motorized transport unit to take actions that might otherwise be prevented due to one or more operating limits. In some embodiments, an apparatus providing control over movement of motorized transport units at a shopping facility, comprises: multiple self-propelled motorized transport units configured to move through at least a portion of a shopping facility; a wireless communication network; and a central computer system that is separate and distinct from the multiple motorized transport units and configured to communicate with each of the multiple motorized transport units via the wireless communication network, wherein the central computer system comprises: a transceiver configured to communicate with the motorized transport units located at the shopping facility; a control circuit coupled with the transceiver; and a memory coupled to the control circuit and storing computer instructions that when executed by the control circuit cause the control circuit to: receive an override command, from a first worker associated with the shopping facility, to cause a first motorized transport unit of the multiple motorized transport units to implement one or more actions; confirm a valid authorization of the first worker to override one or more operating limits of the first motorized transport unit; and override the one or more operating limits and communicate one or more instructions to the first motorized transport unit configured to cause the first motorized transport unit to implement the one or more actions in accordance with the override command.

In some embodiments, a method of providing control over movement of motorized transport units at a shopping facility, comprises: by a control circuit of a shopping facility: receiving an override command, from a first worker associated with a shopping facility, to cause a self-propelled motorized transport unit to implement one or more actions at the shopping facility, wherein the control circuit is separate and distinct from the motorized transport unit; confirming a valid authorization of the first worker to override one or more operating limits of the motorized transport unit; and overriding the one or more operating limits and communicating one or more instructions to the motorized transport unit configured to cause the motorized transport unit to implement the one or more actions in accordance with the override command.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A system providing control over movement of motorized transport units at a facility, comprising:
multiple self-propelled motorized transport units configured to move through at least a portion of the facility;
a computer system that is separate and distinct from the multiple motorized transport units and configured to wirelessly communicate with each of the multiple motorized transport units, wherein the computer system is configured to:
receive an override command corresponding to a first motorized transport unit of the multiple motorized transport units;
confirming a valid authorization to override a previous instruction instructed to be implemented by the first motorized transport unit; and
override the previous instruction and control the first motorized transport unit to implement one or more override instructions to cause the first motorized transport unit to implement one or more actions in accordance with the override command.

2. The system of claim 1, wherein the computer system unit is further configured to:
determine that an additional motorized transport unit is to be utilized based on the override command; and
communicate one or more additional instructions to control a second motorized transport unit of the multiple motorized transport units causing the second motorized transport unit to implement the one or more additional actions.

3. The system of claim 1, wherein the computer system unit is further configured to confirm that a source of the override command has a predefined relationship with a first authorization level.

4. The system of claim 3, wherein the computer system is further configured to confirm that the first authorization level authorizes the source of the override command to override the previous instruction.

5. The system of claim 1, wherein the computer system is further configured to confirm that a source of the override command has a higher level authority based on an override hierarchy over a second source that provided the previous instruction when the override command conflicts with the previous instruction.

6. The system of claim 1, wherein the override command authorizes the first motorized transport unit to implement the one or more actions that exceed a first operating limit.

7. The system of claim 6, wherein the computer system is further configured to:
receive sensor data;
identify the sensor data has a threshold relationship with a sensor threshold corresponding to the first operating limit; and
control the first motorized transport unit to exceed the sensor threshold.

8. The system of claim 1, wherein the computer system is further configured to assign a higher priority to the first motorized transport unit that is greater than a priority of at least one other motorized transport unit of the multiple motorized transport units, and modify a route of the at least one other motorized transport unit.

9. The system of claim 1, wherein the computer system is configured to receive a user interface unit identifier from a portable user interface unit associated with a first user supplying the override command, and confirm the valid authorization of the first user to override the previous instruction based on the user interface unit identifier.

10. The system of claim 9, wherein the computer system is configured to receive, from the portable user interface unit, the override command comprising movement instructions specified through the portable user interface unit.

11. A method of providing control over movement of motorized transport units at a facility, comprising:
receiving an override command corresponding to a first motorized transport unit of the multiple motorized transport units;
confirming a valid authorization to override a previous instruction instructed to be implemented by the motorized transport unit; and
overriding the previous instruction and controlling the first motorized transport unit to implement one or more override instructions causing the motorized transport unit to implement one or more actions in accordance with the override command.

12. The method of claim 11, further comprising:
determining that an additional motorized transport unit is to be utilized based on the override command; and
communicating one or more additional instructions controlling a second motorized transport unit of multiple motorized transport units causing the second motorized transport unit to implement the one or more additional actions.

13. The method of claim 11, further comprising:
confirming that a source of the override command has a predefined relationship with a first authorization level.

14. The method of claim 13, further comprising:
confirming that the first authorization level authorizes the source of the override command to override the previous instruction.

15. The method of claim 11, further comprising:
confirming that the source of the override command has a higher level authority based on an override hierarchy over a second source that provided the previous instruction when the override command conflicts with the previous instruction.

16. The method of claim 11, wherein the controlling the first motorized unit to implement the one or more override instructions comprises authorizing the first motorized transport unit to exceed a first operating limit.

17. The method of claim 16, further comprising:
receiving sensor data;
identifying the sensor data has a threshold relationship with a sensor threshold corresponding to the first operating limit; and
controlling the first motorized transport unit to exceed the sensor threshold.

18. The method of claim 11, further comprising:
assigning a higher priority to the first motorized transport unit that is greater than a priority of at least one other motorized transport unit of the multiple motorized transport units; and
modifying a route of the at least one other motorized transport unit.

19. The method of claim 11, further comprising:
receiving a user interface unit identifier from a portable user interface unit associated with a first user supplying the override command; and
confirming the valid authorization of the first user to override the previous instruction based on the user interface unit identifier.

20. The method of claim 19, further comprising:
receiving, from the portable user interface unit, the override command comprising movement instructions specified through the portable user interface unit.
